(19) United States
(12) Patent Application Publication
(10) Pub. No.: US 2013/0050535 A1
(43) Pub. Date: Feb. 28, 2013

(54) ZOOM LENS AND IMAGING APPARATUS

(71) Applicants: Daisuke Kuroda, Kanagawa (JP); Kenji Ishida, Tokyo (JP)

(72) Inventors: Daisuke Kuroda, Kanagawa (JP); Kenji Ishida, Tokyo (JP)

(73) Assignee: Sony Corporation, Tokyo (JP)

(21) Appl. No.: 13/567,660

(22) Filed: Aug. 6, 2012

(30) Foreign Application Priority Data
Aug. 31, 2011 (JP) 2011-189616

(51) Int. Cl. G02B 15/14; H04N 5/225

(52) U.S. Cl. 348/240.3; 359/683; 348/335; 348/E05.024

(57) ABSTRACT

A zoom lens includes: a first lens group having positive power and fixed during zooming operation; a second lens group having negative power; a third lens group having positive power; a fourth lens group having positive power; and a fifth lens group having positive power sequentially arranged from a side where an object is present, wherein the zooming operation is performed by moving at least the second lens group and the fourth lens group, the first lens group includes a reflective member that deflects an optical path, the fifth lens group includes a first lens partial group having negative power and a second lens partial group having positive power sequentially arranged from the object side, and the zoom lens satisfies the following conditional expressions.

1.1<β5<1.56 (1)

0.1<|F5/Ft|<4 (2)

### FIELD

The present disclosure relates to a zoom lens suitable for a digital still camera, a home-use video camcorder, and other small imaging apparatus and an imaging apparatus using the zoom lens.

### BACKGROUND

In recent years, digital still cameras and other imaging apparatus using a solid-state imaging device have been increasingly used. Higher image quality than ever is typically required as such digital still cameras are widely used. In particular, digital still cameras and other imaging apparatus using a solid-state imaging device having a large number of pixels need an imaging lens having excellent image forming performance corresponding to the large number of pixel, particularly, a zoom lens having such performance. In addition to this, a wider angle of view is typically strongly required in recent years. That is, a compact zoom lens having a zoom ratio ranging from about 4 to 6 and a wide half angle of view of about 40° is typically required.

On the other hand, there are known deflected-type optical systems each intended to reduce the size thereof along the incident optical axis by deflecting the optical path in a position somewhere in the middle thereof (see JP-A-2006-71993, JP-A-2006-276475, JP-A-2006-323051, and JP-A-2009-265557). JP-A-2006-71993, for example, describes the configuration of a deflected-type five-group zoom lens including a first lens group having positive power, a second lens group having negative power, a third lens group having positive power, a fourth lens group having positive power, and a fifth lens group having negative power. The deflected-type zoom lens, which includes a positive lens provided in the fifth lens group and capable of correcting image blur by being shifted in the direction perpendicular to the optical axis, is compact but has a hand-shaking correction mechanism.

JP-A-2006-276475 and JP-A-2006-323051 each provide a five-group zoom lens including a first lens group having positive power, a second lens group having negative power, a third lens group having positive power, a fourth lens group having positive power, and a fifth lens group having positive or negative power. Each of the thus configured zoom lenses is a deflected-type zoom lens that is compact but has a hand-shaking correction mechanism.

### SUMMARY

The optical systems described in JP-A-2006-71993, JP-A-2006-276475, JP-A-2006-323051, and JP-A-2009-265557, however, have angles of view ranging from about 60° to 65°, which are not wide enough to meet the current demands. To allow each of the optical systems to have a wider angle of view, the diameter of the front lens needs to be increased to increase the angle of view, and the length of the zoom lens increases accordingly. In addition to this, the zoom magnification of the optical systems described above ranges from about 3 to 4. The specifications of the optical systems described above hardly meet the current demands of a wider angle of view, a higher magnification, and a smaller size.

It is therefore desirable to provide a zoom lens not only having high image forming performance suitable for a small imaging apparatus but also having a wide angle of view ranging from about 70° to 90° at the wide angle end and a high zoom magnification ranging from about 4 to 6. It is further desirable to provide an imaging apparatus using the zoom lens.

An embodiment of the present disclosure is directed to a zoom lens including a first lens group having positive power and fixed during zooming operation, a second lens group having negative power, a third lens group having positive power, a fourth lens group having positive power, and a fifth lens group having positive power sequentially arranged from a side where an object is present, and the zooming operation is performed by moving at least the second lens group and the fourth lens group. The first lens group includes a reflective member that deflects an optical path, and the fifth lens group includes a first lens partial group having negative power and a second lens partial group having positive power sequentially arranged from the object side. The zoom lens satisfies the following conditional expressions:

1.1<β5<1.56 (1)

0.1<|F5/Ft|<4 (2)

where β5 represents lateral magnification of the fifth lens group, F5 represents the focal length of the fifth lens group, and Ft represents the focal length of the entire system at a telescopic end.

Another embodiment of the present disclosure is directed to an imaging apparatus including a zoom lens and an imaging device that outputs a captured signal according to an optical image formed by the zoom lens, and the zoom lens is configured as described in the embodiment of the present disclosure.

In the zoom lens or the imaging apparatus according to the embodiments of the present disclosure, the power is arranged in the order of positive, negative, positive, positive, and positive from the object side, and zooming operation is performed by moving at least the second lens group and the fourth lens group.

According to the zoom lens or the imaging apparatus according to the embodiments of the present disclosure, five lens groups having positive, negative, positive, positive, and positive power are sequentially arranged from the object side, and the configuration of each of the lens groups is optimized, whereby the resultant zoom lens has not only high image forming performance suitable for a small imaging apparatus but also a wide angle of view ranging from about 70° to 90° at the wide angle end and a high zoom magnification ranging from about 4 to 6.

### BRIEF DESCRIPTION OF THE DRAWINGS

FIG. 1 shows a first exemplary configuration of a zoom lens according to an embodiment of the present disclosure and is a lens cross-sectional view corresponding to Numerical Example 1;

FIG. 2 shows a second exemplary configuration of the zoom lens and is a lens cross-sectional view corresponding to Numerical Example 2;

FIG. 3 shows a third exemplary configuration of the zoom lens and is a lens cross-sectional view corresponding to Numerical Example 3;

FIG. 4 shows a fourth exemplary configuration of the zoom lens and is a lens cross-sectional view corresponding to Numerical Example 4;

FIG. 5 shows a fifth exemplary configuration of the zoom lens and is a lens cross-sectional view corresponding to Numerical Example 5;

FIGS. 6A to 6C are aberration diagrams showing aberrations produced at the wide angle end by the zoom lens corresponding to Numerical Example 1, FIG. 6A showing spherical aberration, FIG. 6B showing astigmatism, and FIG. 6C showing distortion;

FIGS. 7A to 7C are aberration diagrams showing aberrations produced at a point corresponding to an intermediate focal length by the zoom lens corresponding to Numerical Example 1, FIG. 7A showing spherical aberration, FIG. 7B showing astigmatism, and FIG. 7C showing distortion;

FIGS. 8A to 8C are aberration diagrams showing aberrations produced at the telescopic end by the zoom lens corresponding to Numerical Example 1, FIG. 8A showing spherical aberration, FIG. 8B showing astigmatism, and FIG. 8C showing distortion;

FIGS. 9A to 9C are aberration diagrams showing aberrations produced at the wide angle end by the zoom lens corresponding to Numerical Example 2, FIG. 9A showing spherical aberration, FIG. 9B showing astigmatism, and FIG. 9C showing distortion;

FIGS. 10A to 10C are aberration diagrams showing aberrations produced at a point corresponding to an intermediate focal length by the zoom lens corresponding to Numerical Example 2, FIG. 10A showing spherical aberration, FIG. 10B showing astigmatism, and FIG. 10C showing distortion;

FIGS. 11A to 11C are aberration diagrams showing aberrations produced at the telescopic end by the zoom lens corresponding to Numerical Example 2, FIG. 11A showing spherical aberration, FIG. 11B showing astigmatism, and FIG. 11C showing distortion;

FIGS. 12A to 12C are aberration diagrams showing aberrations produced at the wide angle end by the zoom lens corresponding to Numerical Example 3, FIG. 12A showing spherical aberration, FIG. 12B showing astigmatism, and FIG. 12C showing distortion;

FIGS. 13A to 13C are aberration diagrams showing aberrations produced at a point corresponding to an intermediate focal length by the zoom lens corresponding to Numerical Example 3, FIG. 13A showing spherical aberration, FIG. 13B showing astigmatism, and FIG. 13C showing distortion;

FIGS. 14A to 14C are aberration diagrams showing aberrations produced at the telescopic end by the zoom lens corresponding to Numerical Example 3, FIG. 14A showing spherical aberration, FIG. 14B showing astigmatism, and FIG. 14C showing distortion;

FIGS. 15A to 15C are aberration diagrams showing aberrations produced at the wide angle end by the zoom lens corresponding to Numerical Example 4, FIG. 15A showing spherical aberration, FIG. 15B showing astigmatism, and FIG. 15C showing distortion;

FIGS. 16A to 16C are aberration diagrams showing aberrations produced at a point corresponding to an intermediate focal length by the zoom lens corresponding to Numerical Example 4, FIG. 16A showing spherical aberration, FIG. 16B showing astigmatism, and FIG. 16C showing distortion;

FIGS. 17A to 17C are aberration diagrams showing aberrations produced at the telescopic end by the zoom lens corresponding to Numerical Example 4, FIG. 17A showing spherical aberration, FIG. 17B showing astigmatism, and FIG. 17C showing distortion;

FIGS. 18A to 18C are aberration diagrams showing aberrations produced at the wide angle end by the zoom lens corresponding to Numerical Example 5, FIG. 18A showing spherical aberration, FIG. 18B showing astigmatism, and FIG. 18C showing distortion;

FIGS. 19A to 19C are aberration diagrams showing aberrations produced at a point corresponding to an intermediate focal length by the zoom lens corresponding to Numerical Example 5, FIG. 19A showing spherical aberration, FIG. 19B showing astigmatism, and FIG. 19C showing distortion;

FIGS. 20A to 20C are aberration diagrams showing aberrations produced at the telescopic end by the zoom lens corresponding to Numerical Example 5, FIG. 20A showing spherical aberration, FIG. 20B showing astigmatism, and FIG. 20C showing distortion; and

FIG. 21 is a block diagram showing an exemplary configuration of an imaging apparatus.

### DETAILED DESCRIPTION

An embodiment of the present disclosure will be described below in detail with reference to the drawings.

### Basic Configuration of Lens

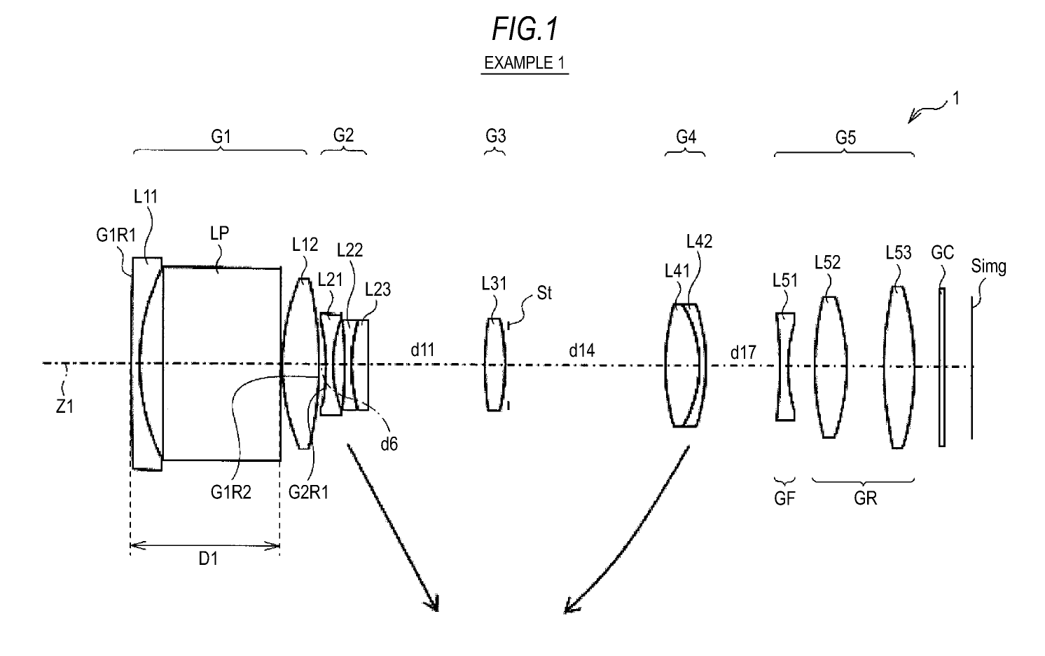

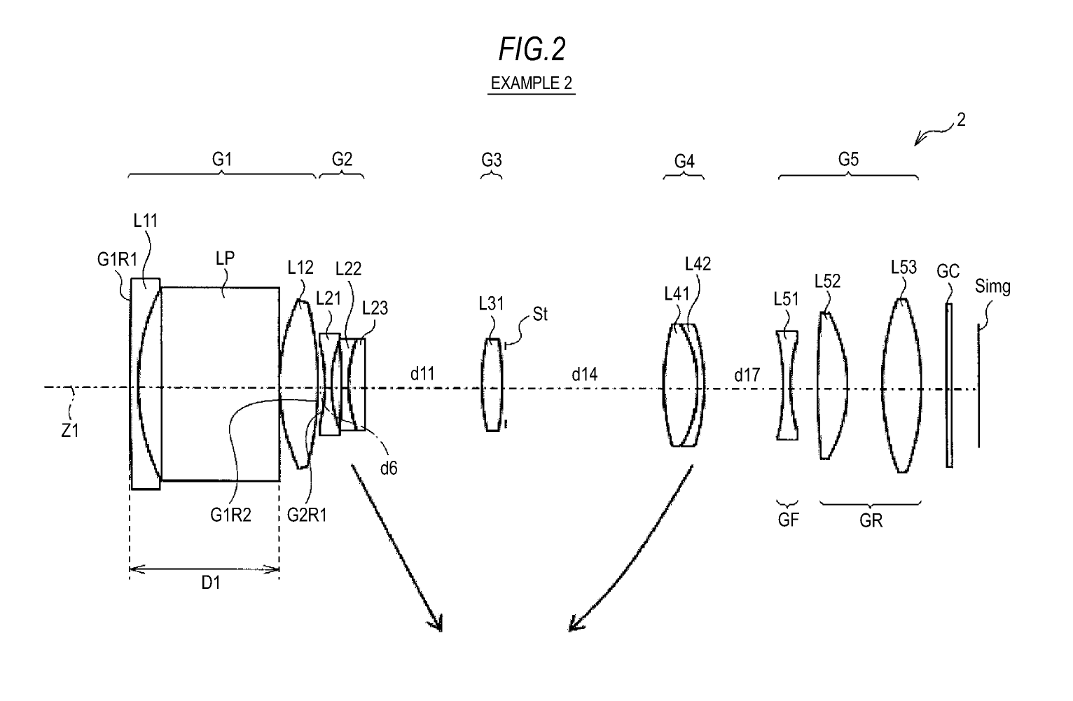

FIG. 1 shows a first exemplary configuration of a zoom lens according to an embodiment of the present disclosure. The exemplary configuration corresponds to a lens configuration according to Numerical Example 1, which will be described later. FIG. 1 corresponds to the lens layout at the wide angle end where an object at infinity is brought into focus. Similarly, FIGS. 2 to 5 show second to fifth exemplary cross-sectional configurations corresponding to lens configurations according to Numerical Examples 2 to 5, which will be described later. In FIGS. 1 to 5, reference character Simg denotes the image plane, and reference characters d6, d11, d14, and d17 each denote the inter-surface distance that changes when the magnification is changed.

The zoom lens according to the present embodiment practically includes the following five lens groups sequentially arranged from the object side along an optical axis Z1: a first lens group G1 having positive power and fixed during zooming operation; a second lens group G2 having negative power; a third lens group G3 having positive power; a fourth lens group G4 having positive power; and a fifth lens group G5 having positive power.

An aperture stop St is preferably disposed between the third lens group G3 and the fourth lens group G4 and in the vicinity of the third lens group G3.

The zoom lens according to the present embodiment performs zooming by moving at least the second lens group G2 and the fourth lens group G4. Specifically, when the magnification is changed from that at the wide angle end to that at the telescopic end, the second lens group G2 is moved in the direction from the object side toward the image plane side and the fourth lens group G4 is moved in the direction from the image plane side toward the object side, as indicated, for example, by the solid lines representing lens group movement paths in the exemplary configurations shown in FIGS. 1 to 5.

The first lens group G1 includes a reflective member LP that deflects the optical path. The reflective member LP can be formed, for example, of a prism having a light incident surface, a reflection surface that deflects the incident optical axis by 90°, and a light exiting surface through which the reflected light passes. In the exemplary configurations shown in FIGS. 1 to 5, the reflection surface is omitted for the convenience of illustration, and the light incident surface and the light exiting surface are so drawn along the optical axis Z1 that they face the same direction, but in practice, the optical axis Z1 is deflected by the reflective member LP. The first lens group G1 preferably includes a first lens L11, which is a single lens having negative power, the reflective member LP, and a second lens L12 having positive power sequentially arranged from the object side.

The fifth lens group G5 includes a first lens partial group GF having negative power and a second lens partial group GR having positive power sequentially arranged from the object side. The first lens partial group GF is preferably formed of a single lens having negative power.

In addition, the zoom lens according to the present embodiment preferably satisfies predetermined conditional expressions that will be described later.

### Advantageous Effects

Advantageous effects provided by the zoom lens according to the present embodiment will next be described.

In the zoom lens according to the present embodiment, since the first lens group G1 accommodates the reflective member LP, the second lens group G2 and the fourth lens group G4 are moved during zooming operation along the optical axis having deflected by the reflective member LP, whereby the thickness of the lens system is reduced. Further, since the zoom lens is configured to have the positive, negative, positive, positive, and positive power arrangement and the zooming operation is performed by moving at least the second lens group G2 and the fourth lens group G4, the diameter of the front lens can be reduced and the lens diameters of the first lens group G1 to the fifth lens group G5 are not greatly differ from one another, whereby the thickness of the zoom lens can be reduced.

In particular, since the fifth lens group G5, which includes the first lens partial group GF having negative power and the second lens partial group GR having positive power sequentially arranged from the object side, has an enlarging ability, the length from the first lens group G1 to the fourth lens group G4 can be reduced.

### Description of Conditional Expressions

Further, when the configurations of the lens groups that form the zoom lens according to the present embodiment are so optimized that the following conditional expressions are satisfied, the zoom lens has high image forming performance suitable for a digital still camera, a home-use video camcorder, and other small imaging apparatus, a wide angle of view ranging from about 70° to 90° at the wide angle end, and a high zoom magnification ranging from about 4 to 6.

The zoom lens according to the present embodiment satisfies the following conditional expressions (1) and (2).

1.1<β5<1.56 (1)

0.1<|F5/Ft|<4 (2)

In Expressions (1) and (2), β5 represents the lateral magnification of the fifth lens group G5, F5 represents the focal length of the fifth lens group G5, and Ft represents the focal length of the entire system at the telescopic end.

The conditional expression (1) defines the lateral magnification β5 of the fifth lens group G5. When β5 is smaller than the lower limit of the conditional expression (1), the enlarging ability of the fifth lens group G5 lowers and it is hence difficult to reduce the size of the zoom lens. On the other hand, when β5 is greater than the upper limit of the conditional expression (1), the enlarging ability of the fifth lens group G5 increases and the size of the zoom lens can therefore be readily reduced, whereas the fifth lens group G5 also increases the amount of aberration produced by the first lens group G1 to the fourth lens group G4 and it is therefore difficult to ensure the optical performance. When the zoom lens satisfies the conditional expression (1), the size of the first lens group G1 can be reduced, and chromatic and comma aberrations resulting from degradation in optical performance at the telescopic end can be suppressed.

The conditional expression (2) defines the ratio of the focal length F5 of the fifth lens group G5 to the focal length Ft of the entire lens system at the telescopic end. When |F5/Ft| is smaller than the lower limit of the conditional expression (2), the power of the fifth lens group G5 lowers and hence the amount of distortion produced by the fifth lens group G5 decrease, resulting in a difficulty in reducing the size and thickness of the first lens group G1. On the other hand, when |F5/Ft| is greater than the upper limit of the conditional expression (2), the power of the fifth lens group G5 increases too much and the amount of distortion produced by the fifth lens group G5 increases too much toward the positive side, resulting in a difficulty in correcting the distortion by the entire lens system as a whole.

In the present embodiment, the following conditional expressions (1)′ and (2)′ may alternatively be satisfied instead of the conditional expressions (1) and (2) described above. When the conditional expressions (1)′ and (2)′ are satisfied, the total length of the optical system can be further reduced and other advantages are achieved.

1.2<β5<1.56 (1)′

0.1<|F5/Ft|<2 (2)′

The zoom lens according to the present embodiment desirably satisfies the following conditional expression (3).

|Fw/G1R1|<1.0 (3)

In Expression (3), G1R1 represents the radius of curvature of the object-side surface of the first lens L11, and Fw represents the focal length of the entire system at the wide angle end.

The conditional expression (3) defines the radius of curvature G1R1 of the object-side surface of the first lens L11 and the focal length Fw of the entire lens system at the wide angle end. When the conditional expression (3) is satisfied, the thickness of the zoom lens, in particular, the thickness thereof along the incident optical axis can be reduced. When |Fw/G1R1| is greater than the upper limit of the conditional expression (3), the absolute value of the radius of curvature G1R1 of the first lens L11 decreases and the thickness of the first lens group G1 increases accordingly, resulting in a difficulty in reducing the thickness of the zoom lens.

In the present embodiment, the following conditional expression (3)′ may alternatively be satisfied instead of the conditional expression (3) described above. When the conditional expression (3)′ is satisfied, the thickness of the zoom lens can be further reduced.

|Fw/G1R1|<0.8 (3)′

The first lens partial group GF, which is formed of a single lens having negative power, is preferably configured to satisfy the following conditional expressions.

NdGF>1.9 (4)

0.6<|FGF/Fw|<2.0 (5)

In Expressions (4) and (5), NdGF represents the refractive index of the first lens partial group GF at the d line, and FGF represents the focal length of the first lens partial group GF.

The first lens partial group GF, which includes a single lens having negative power, can help reduce the total length of the optical system. The conditional expression (4) defines the refractive index of the first lens partial group GF. When NdGF is smaller than the lower limit of the conditional expression (4), it is difficult to correct the Petzval sum of the entire lens system, resulting in a difficulty in correcting field curvature of the image plane. The conditional expression (5) defines the focal length FGF of the first lens partial group GF and the focal length Fw of the entire lens system at the wide angle end. When |FGF/Fw| is smaller than the lower limit of the conditional expression (5), the power of the first lens partial group GF increases too much, resulting in large amounts of various aberrations produced by the fifth lens group G5 and high eccentricity sensitivity, which leads to poor mass productivity of the zoom lens. On the other hand, when |FGF/Fw| is greater than the upper limit of the conditional expression (5), the power of the first lens partial group GF decreases too much, resulting in a difficulty in reducing the size of the zoom lens. When the conditional expressions (4) and (5) are satisfied, the Petzval sum of the entire lens system can be reduced, whereby the field curvature of the image plane can be suppressed. As a result, the size of the zoom lens can be reduced with high optical performance maintained.

In the present embodiment, the following conditional expressions (4)′ and (5)′ may alternatively be satisfied instead of the conditional expressions (4) and (5) described above. When the conditional expressions (4)′ and (5)′ are satisfied, higher performance is achieved.

NdGF>2.0 (4)′

1.0<|FGF/Fw|<1.8 (5)′

The zoom lens according to the present embodiment desirably satisfies the following conditional expression (6).

1.2<G1R2/G2R1<2.0 (6)

In Expression (6), G1R2 represents the radius of curvature of the surface closest to the image side in the first lens group G1, and G2R1 represents the radius of curvature of the surface closest to the object side in the second lens group G2.

The conditional expression (6) defines the ratio of the radius of curvature G1R2 of the surface closest to the image side in the first lens group G1 (image-side surface of second lens L12) to the radius of curvature G2R1 of the surface closest to the object side in the second lens group G2. When G1R2/G2R1 is smaller than the lower limit of the conditional expression (6), residual distortion uncorrected in the first lens group G1 may not be corrected in the following stage, preventing an image processing system from appropriately correcting distortion or causing the size of the first lens L11 to increase and prevent the size of the zoom lens from decreasing. On the other hand, when G1R2/G2R1 is greater than the upper limit of the conditional expression (6), the radius of curvature G2R1 of the surface closest to the object side in the second lens group G2 is further smaller than the radius of curvature G1R2 of the surface of the second lens L12 in the first lens group G1, resulting in high eccentricity sensitivity and hence poor mass productivity of the zoom lens. When the conditional expression (6) is satisfied, the thickness of the first lens group G1 is reduced, whereby the uncorrected distortion can be reduced. As a result, the size of the zoom lens can be reduced, and an image processing system can appropriately control the distortion.

The zoom lens according to the present embodiment desirably satisfies the following conditional expressions (7) and (8).

0.7<|F1/(Fw×Ft)^{1/2}|<1.5 (7)

D1/{(Ft/Fw)×tan(ωw)}<5.0 (8)

In Expressions (7) and (8), F1 represents the focal length of the first lens group G1, D1 represents the distance along the optical axis from the surface closest to the object side in the first lens group G1 to the image-side surface of the reflective member LP, and ωw represents the angle of view at the wide angle end.

The conditional expression (7) defines the focal length F1 of the first lens group G1 and the square root of the product of the focal length Fw of the entire lens system at the wide angle end and the focal length Ft of the entire lens system at the telescopic end. When |F1/(Fw×Ft)^{1/2}| is smaller than the lower limit of the conditional expression (7), the power of the first lens group G1 increases too much, resulting in not only increase in spherical and axial chromatic aberrations produced by the first lens group G1 at the telescopic end but also high eccentricity sensitivity, which leads to poor mass productivity of the zoom lens. On the other hand, when |F1/(Fw×Ft)^{1/2}| is greater than the upper limit of the conditional expression (7), the size of the first lens group G1 disadvantageously increases, resulting in a difficulty in reducing the size of the zoom lens. The conditional expression (8) defines the distance from G1R1 to G2R2, the angle of view cow at the wide angle end, and the zoom magnification (Ft/Fw). When D1/{(Ft/Fw)×tan(ωw)} is greater than the upper limit of the conditional expression (8), the size of the first lens group G1 disadvantageously increases, resulting in a difficulty in reducing the size of the zoom lens. When the conditional expressions (7) and (8) are satisfied, the thickness of the zoom lens, particularly, the size of the first lens group G1, can be reduced, which leads to a decrease in the thickness of the zoom lens along the incident optical axis.

The zoom lens according to the present embodiment desirably satisfies the following conditional expressions (9) and (10).

NdG1>1.9 (9)

NdPr>1.9 (10)

In Expressions (9) and (10), NdG1 represents the refractive index of the first lens L11 in the first lens group G1 at the d line, and NdPr represents the refractive index of the reflective member LP at the d line.

The conditional expression (9) defines the refractive index of the first lens L11 at the d line. When NdG1 is smaller than the lower limit of the conditional expression (9), the size of the first lens group G1 disadvantageously increases, resulting in a difficulty in reducing the size of the zoom lens. The conditional expression (10) defines the refractive index of the reflective member LP at the d line. When NdPr is smaller the lower limit of the conditional expression (10), the size of the first lens group G1 disadvantageously increases, resulting in a difficulty in reducing the size of the zoom lens. When the conditional expressions (9) and (10) are satisfied, the thickness of the zoom lens, particularly, the size of the first lens group G1, can be reduced, which leads to a decrease in the thickness of the zoom lens along the incident optical axis.

### Other Desirable Configurations

In addition to the conditions described above, the zoom lens according to the present embodiment is desirably configured as follows.

An image can be shifted by moving (shifting) one of the first lens group G1 to the fifth lens group G5 or part of the one lens group as an anti-vibration lens group in a direction substantially perpendicular to the optical axis Z1. In this case, the zoom lens can function as an anti-vibration optical system, for example, by combining a detection system that detects image blur, a drive system that shifts the anti-vibration lens group, and a control system that supplies the drive system with the amount of shift determined by an output from the detection system. In particular, in the zoom lens according to the present embodiment, an image can be shifted with a small amount of change in aberration by shifting a single positive lens in the fifth lens group G5 in a direction substantially perpendicular to the optical axis Z1.

Focusing is preferably performed by moving the fourth lens group G4 along the optical axis. In particular, when the fourth lens group G4 is used as a focusing lens group, interference with the drive system, which drives and controls a shutter unit and an iris unit, and the anti-vibration drive system, which shifts the anti-vibration lens group, is readily avoided, and the size of the zoom lens can be reduced.

An optical member GC, such as a cover glass plate, may be disposed on the image side of the lens system. The optical member GC may be a lowpass filter for preventing moire fringes from occurring or an infrared blocking filter depending on the spectral sensitivity characteristics of a light detector.

Further, when the zoom lens according to the present embodiment is incorporated in an imaging apparatus, it is desirable to provide a signal processor that performs distortion correction on a captured image produced from a captured signal. For example, in an imaging apparatus 100, which will be described later, a camera signal processor 20 desirably performs the distortion correction. In the zoom lens according to the present embodiment, which provides a wide angle of view ranging from about 70° to 90° at the wide angle end and a high zoom magnification ratio ranging from about 4 to 6, distortion at the wide angle end greatly differs from distortion at the telescopic end. The thin zoom lens according to the present embodiment is achieved by providing the imaging apparatus with a function of correcting the distortion.

### Example of Incorporation of Zoom Lens Into Imaging Apparatus

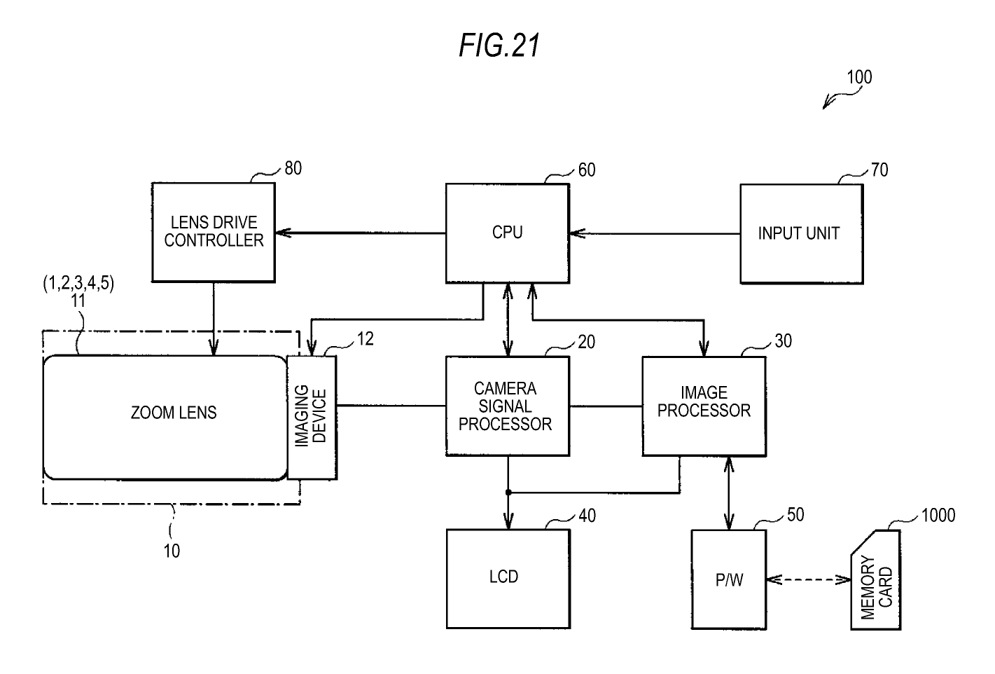

FIG. 21 shows an exemplary configuration of the imaging apparatus 100 into which the zoom lens according to the present embodiment is incorporated. The imaging apparatus 100 is, for example, a digital still camera and includes a camera block 10, a camera signal processor 20, an image processor 30, an LCD (liquid crystal display) 40, an R/W (reader/writer) 50, a CPU (central processing unit) 60, and an input unit 70.

The camera block 10 is responsible for imaging and includes an optical system including a zoom lens 11 (any of the zoom lenses 1, 2, 3, 4, and 5 shown in FIGS. 1 to 5) and an imaging device 12, such as a CCD (charge coupled device) and a CMOS (complementary metal oxide semiconductor) device. The imaging device 12 converts an optical image formed by the zoom lens 11 into an electric signal and outputs a captured signal (image signal) according to the optical image.

The camera signal processor 20 processes the image signal outputted from the imaging device 12 and performs analog-digital conversion, noise removal, image quality correction, conversion to a luminance/color difference signal, and a variety of types of other signal processing. The image quality correction is, for example, the distortion correction performed on a captured image.

The image processor 30 records and reproduces the image signal, performs compression encoding and decompression decoding on the image signal based on a predetermined image data format, performs data format conversion, such as resolution conversion, and performs other image processing.

The LCD 40 has a function of displaying a variety of data, such as user's operation through the input unit 70 and captured images. The R/W 50 writes image data encoded by the image processor 30 to a memory card 1000 and reads image data recorded on the memory card 1000. The memory card 1000 is, for example, a semiconductor memory that can be attached to and detached from a slot connected to the R/W 50.

The CPU 60 functions as a control processor that controls circuit blocks provided in the imaging apparatus 100 and controls each of the circuit blocks based, for example, on an instruction input signal from the input unit 70. The input unit 70, which is formed of a variety of switches and other components operated by the user as necessary, includes, for example, a shutter release button for shutter operation and a selection switch for selecting an action mode and outputs an instruction input signal according to user's operation to the CPU 60. A lens drive controller 80, which controls driving of the lens disposed in the camera block 10, controls a motor or any other actuator (not shown) that drives lenses in the zoom lens 11 based on a control signal from the CPU 60.

The operation of the imaging apparatus 100 will be described below.

In an imaging standby state, an image signal captured by the camera block 10 is outputted to the LCD 40 via the camera single processor 20 and displayed as camera-through images on the LCD 40 under the control of the CPU 60. When a zooming instruction input signal is inputted from the input unit 70, the CPU 60 outputs a control signal to the lens drive controller 80, and a predetermined lens in the zoom lens 11 is moved under the control of the lens drive controller 80.

When the shutter (not shown) in the camera block 10 is operated in response to an instruction input signal from the input unit 70, the camera signal processor 20 outputs a captured image signal to the image processor 30, which performs compression encoding on the image signal and converts the encoded image signal into digital data expressed in a predetermined data format. The converted data is outputted to the R/W 50, which writes the data to the memory card 1000.

Focusing is carried out, for example, as follows: When the shutter release button in the input unit 50 is pressed halfway or fully pressed for recording (imaging), the lens drive controller 80 moves a predetermined lens in the zoom lens 11 based on a control signal from the CPU 60.

To reproduce image data recorded on the memory card 1000, the R/W 50 reads predetermined image data from the memory card 1000 in response to user's operation performed through the input unit 70. The image processor 30 performs decompression decoding on the read image data, and an image signal to be reproduced is then outputted to the LCD 40 and displayed thereon as reproduced images.

The above embodiment has been described with reference to the case where the imaging apparatus is used as a digital still camera. It is, however, noted that the imaging apparatus is not necessarily used as a digital still camera but can be widely used as a camera portion of a digital input/output apparatus, such as a digital video camcorder, a mobile phone into which a camera is incorporated, and a PDA (personal digital assistant) into which a camera is incorporated.

### EXAMPLES

Specific numerical examples of the zoom lens according to the present embodiment will next be described.

The meanings and other information of the symbols shown in the following tables and descriptions are as follows: “i” denotes the number of an i-th surface with “i” starting from 1 representing the component surface closest to the object side and sequentially incrementing in the direction toward the image side. “ri” denotes the radius of curvature (mm) of an i-th surface. “di” denotes the distance (mm) along the optical axis between an i-th surface and an (i+1)-th surface. “ni” denotes the refractive index of the material of an optical component having an i-th surface at the d line (wavelength: 587.6 nm). “vi” denotes the Abbe number of the material of the optical component having an i-th surface at the d line. “Fno” denotes an f-number. “f” denotes the focal length of the entire system. “ω” denotes half an angle of view.

A field where “di” is “variable” means that the inter-surface distance is variable. A field where “ri” is “INFINITY” means that the surface is a flat surface or a stop surface. A surface number with “STO” represents a stop surface. “IMG” represents the image plane. A surface labeled with “ASP” is an aspheric surface, and the shape of an aspheric surface is expressed by the following expression. In aspheric coefficient data, symbol “E” means that the following numerical value is the “exponent” of base 10 and that the numerical value expressed by the exponent function using base 10 is multiplied by the numerical value preceding “E”. For example, “1.0E-05” represents “1.0×10^{-5.”}

### Expression of Aspheric Surface

$$x = \frac{{y}^{2} \cdot {c}^{2}}{1 + {( 1 - ( 1 + K ) \cdot {y}^{2} \cdot {c}^{2} )}^{1 / 2}} + Σ Ai \cdot Yi$$

where “x” denotes the distance along the optical axis from the vertex of the lens surface; “y” denotes the height in the direction perpendicular to the optical axis; “c” denotes paraxial curvature at the vertex of the lens; “K” denotes a conic constant; and “Ai” denote an i-th aspheric coefficient.

Zoom lenses 1 to 5 according to the following numerical examples each practically include the following five lens groups sequentially arranged from the object side along the optical axis Z1: a first lens group G1 having positive power and fixed during zooming operation; a second lens group G2 having negative power; a third lens group G3 having positive power; a fourth lens group G4 having positive power; and a fifth lens group G5 having positive power. An aperture stop St is disposed between the third lens group G3 and the fourth lens group G4 and in the vicinity of the third lens group G3. A flat-plate-shaped optical member GC, such as a cover glass plate, is disposed between the fifth lens group G5, which is the last lens group, and the image plane Simg. When the magnification is changed from that at the wide angle end to that at the telescopic end, the second lens group G2 is moved in the direction from the object side toward the image plane side and the fourth lens group G4 is moved in the direction from the image plane side toward the object side.

### Numerical Example 1

“Table 1” to “Table 4” show specific lens data corresponding to the zoom lens 1 according to the first exemplary configuration shown in FIG. 1. In particular, “Table 1” shows basic lens data on the zoom lens 1, and “Table 2” shows data on aspheric surfaces thereof. “Table 3” and “Table 4” show other data. Since the zoom lens 1 is so configured that the second lens group G2 and the fourth lens group G4 are moved when the magnification is changed, the inter-surface distances in front of and behind the lens groups G2 and G4 are variable. “Table 3” shows the variable inter-surface distances along with Fno., f, and co at the wide angle end, a point corresponding to an intermediate focal length, and the telescopic end. “Table 4” shows the surface number of the first surface and the focal length of each of the lens groups.

In the zoom lens 1, the first lens group G1 includes a negative meniscus lens (first lens L11), a prism that deflects the optical axis Z1 by 90° (reflective member LP), and a biconvex lens having aspheric surfaces on both sides (second lens L12) sequentially arranged from the object side. The second lens group G2 includes a biconcave lens L21 having aspheric surfaces on both sides and a doublet formed of a biconcave lens L22 and a positive lens L23 sequentially arranged from the object side. The third lens group G3 includes only a biconvex lens L31 having an aspheric surface on the object side. The fourth lens group G4 includes a doublet formed of a biconvex lens L41 having an aspheric surface on the object side and a negative meniscus lens L42 sequentially arranged from the object side. The fifth lens group G5 includes a biconcave lens L51, a biconvex lens L52 having aspheric surfaces on both sides, and a biconvex lens L53 having an aspheric surface on the object side sequentially arranged from the object side. The biconcave lens L51 forms the first lens partial group GF. The biconvex lens L52 and the biconvex lens L53 form the second lens partial group GR.

TABLE 1
Example 1

| Lens | | | | | | |
|---|---|---|---|---|---|---|
| group | i | ri | ASP | di | ni | νi |
| G1 | 1 | 205.000 | | 0.500 | 2.00270 | 19.32 |
| | 2 | 12.400 | | 1.400 | | |
| | 3 | INFINITY | | 7.000 | 2.00100 | 29.13 |
| | 4 | INFINITY | | 0.100 | | |
| | 5 | 11.6213 | ASP | 2.220 | 1.80139 | 45.45 |
| | 6 | −18.047 | ASP | variable | | |
| G2 | 7 | −11.007 | ASP | 0.400 | 1.88202 | 37.22 |
| | 8 | 6.530 | ASP | 0.670 | | |
| | 9 | −22.450 | | 0.400 | 1.83481 | 42.72 |
| | 10 | 7.670 | | 1.000 | 1.94595 | 17.98 |
| | 11 | 131.500 | | variable | | |
| G3 | 12 | 13.7381 | ASP | 1.200 | 1.58313 | 59.46 |
| | 13 | −14.270 | | 0.200 | | |
| | 14 (STO) | INFINITY | | variable | | |
| G4 | 15 | 11.823 | ASP | 2.000 | 1.59201 | 67.02 |
| | 16 | −6.930 | | 0.400 | 1.84663 | 23.78 |
| | 17 | −10.920 | | variable | | |
| G5 | 18 | −21.240 | | 0.420 | 2.00060 | 25.46 |
| | 19 | 8.160 | | 1.645 | | |
| | 20 | 16.999 | ASP | 1.850 | 1.52470 | 56.24 |
| | 21 | −10.897 | ASP | 2.200 | | |
| | 22 | 18.648 | ASP | 1.840 | 1.52470 | 56.24 |
| | 23 | −17.350 | | 1.520 | | |
| | 24 | INFINITY | | 0.300 | 1.556708 | 58.56 |
| | 25 | INFINITY | | 1.600 | | |
| | IMG | INFINITY | | 0.000 | | |

TABLE 2
Example 1/Aspheric surface data

| i | K | A4 | A6 | A8 | A10 |
|---|---|---|---|---|---|
| 5 | 0.0000E+00 | −8.4896E−05 | 3.1666E−08 | 2.2716E−08 | −2.5387E−09 |
| 6 | 0.0000E+00 | 1.1413E−04 | 1.6286E−07 | −1.2745E−08 | −1.5308E−09 |
| 7 | 0.0000E+00 | −1.2134E−04 | 1.2932E−04 | −9.7703E−06 | 2.5454E−07 |
| 8 | 0.0000E+00 | −1.4073E−03 | 1.6480E−04 | −8.8420E−06 | 9.8939E−08 |
| 12 | 0.0000E+00 | −2.9606E−04 | −5.2730E−06 | 1.8967E−06 | −1.4085E−07 |
| 15 | 0.0000E+00 | −2.7975E−04 | 6.5590E−06 | −3.8614E−07 | 6.5317E−09 |
| 20 | 0.0000E+00 | 2.1648E−04 | −8.9089E−06 | 0.0000E+00 | 0.0000E+00 |
| 21 | 0.0000E+00 | 5.5044E−04 | −8.7837E−06 | 0.0000E+00 | 0.0000E+00 |
| 22 | 0.0000E+00 | −1.1753E−04 | −2.5246E−06 | 0.0000E+00 | 0.0000E+00 |

TABLE 3
Example 1

| | Wide | | Telescopic |
|---|---|---|---|
| | angle end | Intermediate | end |
| f | 4.89 | 10.48 | 22.45 |
| Fno. | 3.69 | 4.10 | 5.51 |
| ω | 40.06 | 19.04 | 8.94 |
| d6 | 0.402 | 4.557 | 7.000 |
| d11 | 6.898 | 2.744 | 0.300 |
| d14 | 9.400 | 6.109 | 2.312 |
| d17 | 4.435 | 7.726 | 11.523 |

TABLE 4
Example 1

| Lens | First | Focal |
|---|---|---|
| group | surface | length |
| G1 | 1 | 12.563 |
| G2 | 7 | −3.948 |
| G3 | 12 | 12.148 |
| G4 | 15 | 11.353 |
| G5 | 18 | 31.467 |

### Numerical Example 2

“Table 5” to “Table 8” show specific lens data corresponding to the zoom lens 2 according to the second exemplary configuration shown in FIG. 2. In particular, “Table 5” shows basic lens data on the zoom lens 2, and “Table 6” shows data on aspheric surfaces thereof. “Table 7” and “Table 8” show other data. Since the zoom lens 2 is so configured that the second lens group G2 and the fourth lens group G4 are moved when the magnification is changed, the inter-surface distances in front of and behind the lens groups G2 and G4 are variable. “Table 7” shows the variable inter-surface distances along with Fno., f, and co at the wide angle end, a point corresponding to an intermediate focal length, and the telescopic end. “Table 8” shows the surface number of the first surface and the focal length of each of the lens groups.

In the zoom lens 2, the first lens group G1 includes a negative meniscus lens (first lens L11), a prism that deflects the optical axis Z1 by 90° (reflective member LP), and a biconvex lens having aspheric surfaces on both sides (second lens L12) sequentially arranged from the object side. The second lens group G2 includes a biconcave lens L21 having aspheric surfaces on both sides and a doublet formed of a biconcave lens L22 and a positive lens L23 sequentially arranged from the object side. The third lens group G3 includes only a biconvex lens L31 having aspheric surfaces on both sides. The fourth lens group G4 includes a doublet formed of a biconvex lens L41 having an aspheric surface on the object side and a negative meniscus lens L42 sequentially arranged from the object side. The fifth lens group G5 includes a biconcave lens L51, a biconvex lens L52 having aspheric surfaces on both sides, and a biconvex lens L53 having an aspheric surface on the object side sequentially arranged from the object side. The biconcave lens L51 forms the first lens partial group GF. The biconvex lens L52 and the biconvex lens L53 form the second lens partial group GR.

TABLE 5
Example 2

| Lens | | | | | | |
|---|---|---|---|---|---|---|
| group | i | ri | ASP | di | ni | νi |
| G1 | 1 | 202.426 | | 0.500 | 2.00270 | 19.32 |
| | 2 | 12.391 | | 1.400 | | |
| | 3 | INFINITY | | 7.000 | 2.00100 | 29.13 |
| | 4 | INFINITY | | 0.100 | | |
| | 5 | 11.5750 | ASP | 2.223 | 1.80139 | 45.45 |
| | 6 | −17.950 | ASP | variable | | |
| G2 | 7 | −10.948 | ASP | 0.400 | 1.88202 | 37.22 |
| | 8 | 6.462 | ASP | 0.678 | | |
| | 9 | −22.524 | | 0.400 | 1.83481 | 42.72 |
| | 10 | 7.833 | | 0.994 | 1.94595 | 17.98 |
| | 11 | 201.740 | | variable | | |
| G3 | 12 | 12.5717 | ASP | 1.201 | 1.58313 | 59.46 |
| | 13 | −15.820 | ASP | 0.200 | | |
| | 14 (STO) | INFINITY | | variable | | |
| G4 | 15 | 12.088 | ASP | 1.985 | 1.59201 | 67.02 |
| | 16 | −6.913 | | 0.400 | 1.84663 | 23.78 |
| | 17 | −10.987 | | variable | | |
| G5 | 18 | −15.420 | | 0.420 | 2.00100 | 29.13 |
| | 19 | 8.720 | | 1.600 | | |
| | 20 | 42.722 | ASP | 1.855 | 1.52470 | 56.24 |
| | 21 | −7.618 | ASP | 2.073 | | |
| | 22 | 14.768 | ASP | 2.267 | 1.52470 | 56.24 |
| | 23 | −15.441 | | 1.500 | | |
| | 24 | INFINITY | | 0.300 | 1.556708 | 58.56 |
| | 25 | INFINITY | | 1.600 | | |
| | IMG | INFINITY | | 0.000 | | |

TABLE 6
Example 2/Aspheric surface data

| i | K | A4 | A6 | A8 | A10 |
|---|---|---|---|---|---|
| 5 | 0.0000E+00 | −7.6278E−05 | −1.6271E−07 | 1.7848E−08 | −2.1849E−09 |
| 6 | 0.0000E+00 | 1.2911E−04 | −2.9690E−07 | −5.6917E−09 | −1.3867E−09 |
| 7 | 0.0000E+00 | −4.1244E−05 | 1.2154E−04 | −9.0799E−06 | 2.4344E−07 |
| 8 | 0.0000E+00 | −1.4022E−03 | 1.7473E−04 | −1.1989E−05 | 4.8026E−07 |
| 12 | 0.0000E+00 | −2.4985E−04 | 3.8408E−05 | −8.6751E−07 | 1.0541E−07 |
| 13 | 0.0000E+00 | 6.2713E−05 | 3.7574E−05 | −1.6424E−06 | 1.7390E−07 |
| 15 | 0.0000E+00 | −2.8407E−04 | 9.9065E−06 | −7.1485E−07 | 2.0088E−08 |
| 20 | 0.0000E+00 | 9.5367E−05 | −1.2426E−05 | 0.0000E+00 | 0.0000E+00 |
| 21 | 0.0000E+00 | 5.5044E−04 | −8.7837E−06 | 0.0000E+00 | 0.0000E+00 |

TABLE 7
Example 2

| | Wide | | Telescopic |
|---|---|---|---|
| | angle end | Intermediate | end |
| f | 4.89 | 10.48 | 22.47 |
| Fno. | 4.03 | 4.37 | 5.55 |
| ω | 36.03 | 16.20 | 7.58 |
| d6 | 0.400 | 4.531 | 7.000 |
| d11 | 6.900 | 2.769 | 0.300 |
| d14 | 9.400 | 6.077 | 2.311 |
| d17 | 4.703 | 8.027 | 11.792 |

TABLE 8
Example 2

| Lens | First | Focal |
|---|---|---|
| group | surface | length |
| G1 | 1 | 12.455 |
| G2 | 7 | −3.966 |
| G3 | 12 | 12.155 |
| G4 | 15 | 11.554 |
| G5 | 18 | 19.176 |

### Numerical Example 3

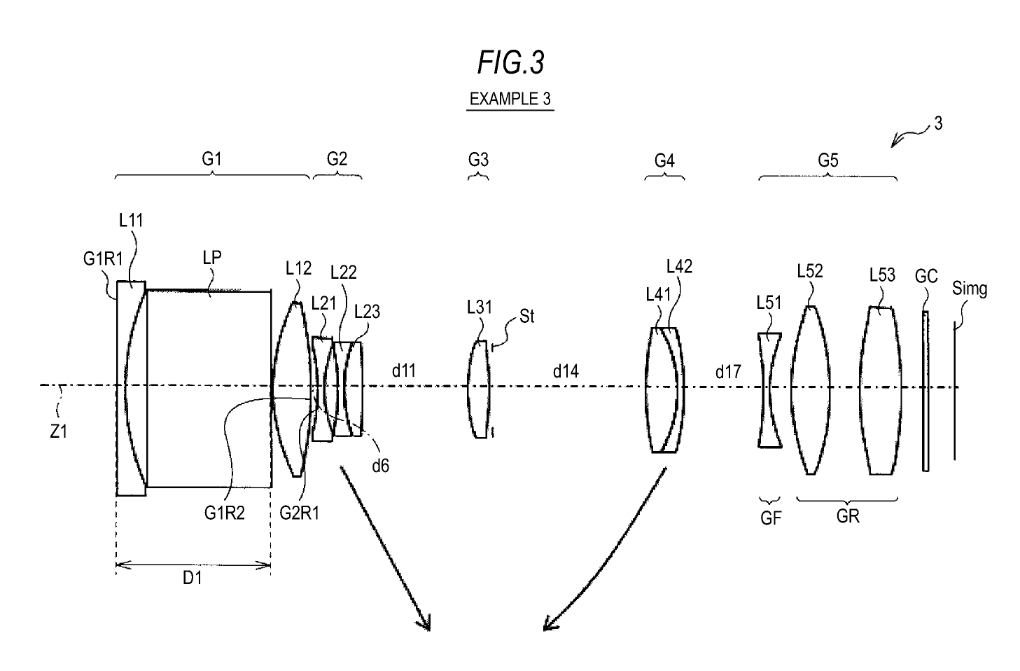

“Table 9” to “Table 12” show specific lens data corresponding to the zoom lens 3 according to the third exemplary configuration shown in FIG. 3. In particular, “Table 9” shows basic lens data on the zoom lens 3, and “Table 10” shows data on aspheric surfaces thereof. “Table 11” and “Table 12” show other data. Since the zoom lens 3 is so configured that the second lens group G2 and the fourth lens group G4 are moved when the magnification is changed, the inter-surface distances in front of and behind the lens groups G2 and G4 are variable. “Table 11” shows the variable inter-surface distances along with Fno., f, and co at the wide angle end, a point corresponding to an intermediate focal length, and the telescopic end. “Table 12” shows the surface number of the first surface and the focal length of each of the lens groups.

In the zoom lens 3, the first lens group G1 includes a negative meniscus lens (first lens L11), a prism that deflects the optical axis Z1 by 90° (reflective member LP), and a biconvex lens having aspheric surfaces on both sides (second lens L12) sequentially arranged from the object side. The second lens group G2 include a biconcave lens L21 having aspheric surfaces on both sides and a doublet formed of a biconcave lens L22 and a positive lens L23 sequentially arranged from the object side. The third lens group G3 includes only a biconvex lens L31 having aspheric surfaces on both sides. The fourth lens group G4 includes a doublet formed of a biconvex lens L41 having an aspheric surface on the object side and a negative meniscus lens L42 sequentially arranged from the object side. The fifth lens group G5 includes a biconcave lens L51, a biconvex lens L52 having aspheric surfaces on both sides, and a biconvex lens L53 having aspheric surfaces on both sides sequentially arranged from the object side. The biconcave lens L51 forms the first lens partial group GF. The biconvex lens L52 and the biconvex lens L53 form the second lens partial group GR.

TABLE 9
Example 3

| Lens | | | | | | |
|---|---|---|---|---|---|---|
| group | i | ri | ASP | di | ni | νi |
| G1 | 1 | 2107.000 | | 0.500 | 2.00270 | 19.32 |
| | 2 | 14.820 | | 1.300 | | |
| | 3 | INFINITY | | 7.500 | 2.00100 | 29.13 |
| | 4 | INFINITY | | 0.100 | | |
| | 5 | 10.8644 | ASP | 2.320 | 1.77377 | 47.17 |
| | 6 | −18.733 | ASP | variable | | |
| G2 | 7 | −11.104 | ASP | 0.400 | 1.88202 | 37.22 |
| | 8 | 6.591 | ASP | 0.790 | | |
| | 9 | −13.320 | | 0.400 | 1.91082 | 35.25 |
| | 10 | 8.110 | | 1.130 | 1.94595 | 17.98 |
| | 11 | −40.650 | | variable | | |
| G3 | 12 | 11.3155 | ASP | 1.230 | 1.72903 | 54.04 |
| | 13 | −17.409 | ASP | 0.200 | | |
| | 14 (STO) | INFINITY | | variable | | |
| G4 | 15 | 15.921 | ASP | 1.840 | 1.72903 | 54.04 |
| | 16 | −7.580 | | 0.400 | 1.84663 | 23.78 |
| | 17 | −15.900 | | variable | | |
| G5 | 18 | −22.230 | | 0.430 | 2.00060 | 25.46 |
| | 19 | 8.700 | | 1.300 | | |
| | 20 | 12.445 | ASP | 2.300 | 1.52470 | 56.24 |
| | 21 | −13.608 | ASP | 1.800 | | |
| | 22 | 19.429 | ASP | 2.500 | 1.58913 | 61.25 |
| | 23 | −14.371 | ASP | 1.300 | | |
| | 24 | INFINITY | | 0.300 | 1.556708 | 58.56 |
| | 25 | INFINITY | | 1.600 | | |
| | IMG | INFINITY | | 0.000 | | |

TABLE 10
Example 3/Aspheric surface data

| i | K | A4 | A6 | A8 | A10 |
|---|---|---|---|---|---|
| 5 | 0.0000E+00 | −9.6470E−05 | 5.4782E−07 | −1.8906E−08 | −1.0954E−09 |
| 6 | 0.0000E+00 | 1.3579E−04 | 6.7504E−07 | −6.0019E−08 | 3.0905E−11 |
| 7 | 0.0000E+00 | 4.9094E−04 | 2.7690E−05 | −2.6242E−06 | 1.3279E−07 |
| 8 | 0.0000E+00 | −6.9749E−04 | 6.4471E−05 | −5.5060E−06 | 4.9195E−07 |
| 12 | 0.0000E+00 | 2.1426E−04 | 7.7924E−05 | −3.0522E−06 | 7.0473E−07 |
| 13 | 0.0000E+00 | 5.5787E−04 | 8.2097E−05 | −4.3689E−06 | 9.0857E−07 |
| 15 | 0.0000E+00 | −1.4549E−04 | 5.7864E−06 | −4.4618E−07 | 1.3044E−08 |
| 20 | 0.0000E+00 | 3.1384E−05 | −8.8420E−06 | 0.0000E+00 | 0.0000E+00 |
| 21 | 0.0000E+00 | 3.8224E−04 | −1.3789E−05 | 0.0000E+00 | 0.0000E+00 |
| 22 | 0.0000E+00 | 6.3478E−04 | −2.5564E−05 | 0.0000E+00 | 0.0000E+00 |
| 23 | 0.0000E+00 | 1.5374E−03 | −5.5976E−05 | 1.8680E−07 | 1.0066E−08 |

TABLE 11
Example 3

| | Wide | | Telescopic |
|---|---|---|---|
| | angle end | Intermediate | end |
| f | 5.00 | 10.29 | 21.14 |
| Fno. | 3.61 | 3.95 | 4.90 |
| ω | 39.29 | 19.61 | 9.54 |
| d6 | 0.405 | 4.073 | 6.392 |
| d11 | 6.317 | 2.649 | 0.330 |
| d14 | 9.300 | 5.950 | 2.398 |
| d17 | 4.795 | 8.146 | 11.698 |

TABLE 12
Example 3

| Lens | First | Focal |
|---|---|---|
| group | surface | length |
| G1 | 1 | 12.047 |
| G2 | 7 | −3.863 |
| G3 | 12 | 11.730 |
| G4 | 15 | 12.288 |
| G5 | 18 | 19.862 |

### Numerical Example 4

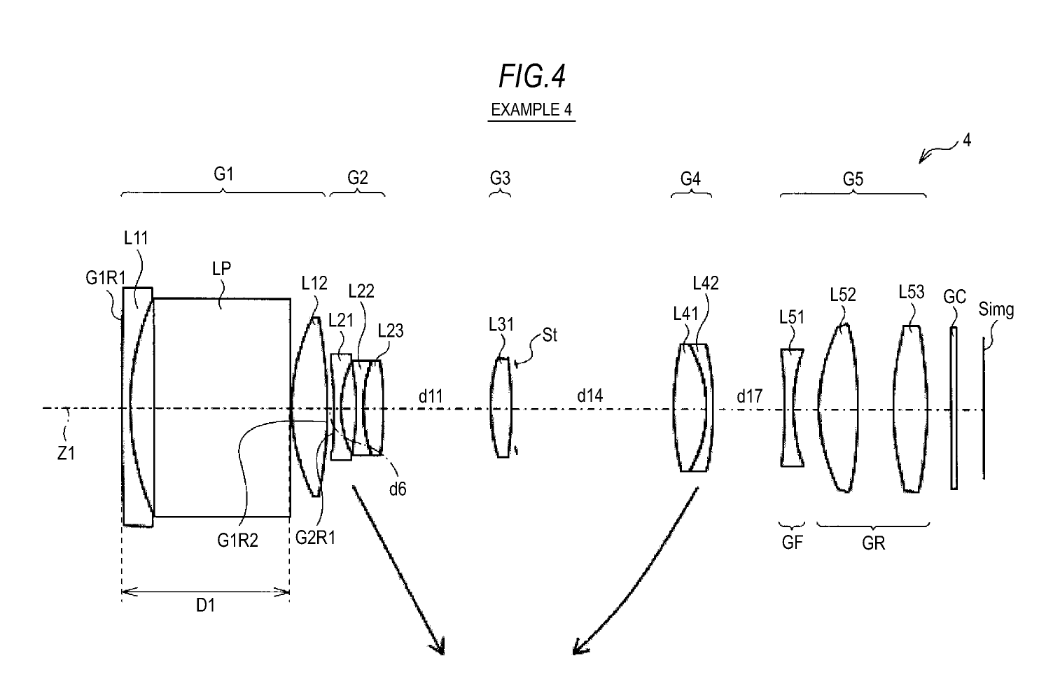

“Table 13” to “Table 16” show specific lens data corresponding to the zoom lens 4 according to the fourth exemplary configuration shown in FIG. 4. In particular, “Table 13” shows basic lens data on the zoom lens 4, and “Table 14” shows data on aspheric surfaces thereof. “Table 15” and “Table 16” show other data. Since the zoom lens 4 is so configured that the second lens group G2 and the fourth lens group G4 are moved when the magnification is changed, the inter-surface distances in front of and behind the lens groups G2 and G4 are variable. “Table 15” shows the variable inter-surface distances along with Fno., f, and co at the wide angle end, a point corresponding to an intermediate focal length, and the telescopic end. “Table 16” shows the surface number of the first surface and the focal length of each of the lens groups.

In the zoom lens 4, the first lens group G1 includes a negative meniscus lens (first lens L11), a prism that deflects the optical axis Z1 by 90° (reflective member LP), and a biconvex lens having aspheric surfaces on both sides (second lens L12) sequentially arranged from the object side. The second lens group G2 includes a biconcave lens L21 having aspheric surfaces on both sides and a doublet formed of a biconcave lens L22 and a positive lens L23 sequentially arranged from the object side. The third lens group G3 includes only a biconvex lens L31 having aspheric surfaces on both sides. The fourth lens group G4 includes a doublet formed of a biconvex lens L41 having an aspheric surface on the object side and a negative meniscus lens L42 sequentially arranged from the object side. The fifth lens group G5 includes a biconcave lens L51, a biconvex lens L52 having aspheric surfaces on both sides, and a biconvex lens L53 having aspheric surfaces on both sides sequentially arranged from the object side. The biconcave lens L51 forms the first lens partial group GF. The biconvex lens L52 and the biconvex lens L53 form the second lens partial group GR.

TABLE 13
Example 4

| Lens | | | | | | |
|---|---|---|---|---|---|---|
| group | i | ri | ASP | di | ni | νi |
| G1 | 1 | 119.700 | | 0.500 | 2.00270 | 19.32 |
| | 2 | 15.283 | | 1.439 | | |
| | 3 | INFINITY | | 8.000 | 1.90366 | 31.32 |
| | 4 | INFINITY | | 0.100 | | |
| | 5 | 10.7101 | ASP | 2.160 | 1.76802 | 49.24 |
| | 6 | −23.544 | ASP | variable | | |
| G2 | 7 | −17.000 | ASP | 0.400 | 1.88202 | 37.22 |
| | 8 | 6.196 | ASP | 0.891 | | |
| | 9 | −9.536 | | 0.400 | 1.91082 | 35.25 |
| | 10 | 8.448 | | 1.148 | 1.94595 | 17.98 |
| | 11 | −30.626 | | variable | | |
| G3 | 12 | 12.0259 | ASP | 1.232 | 1.59201 | 67.02 |
| | 13 | −15.632 | ASP | 0.200 | | |
| | 14 (STO) | INFINITY | | variable | | |
| G4 | 15 | 15.887 | ASP | 1.876 | 1.72903 | 54.04 |
| | 16 | −7.423 | | 0.400 | 1.84663 | 23.78 |
| | 17 | −15.623 | | variable | | |
| G5 | 18 | −27.197 | | 0.430 | 2.00060 | 25.46 |
| | 19 | 9.110 | | 1.600 | | |
| | 20 | 10.354 | ASP | 2.300 | 1.52470 | 56.24 |
| | 21 | −20.300 | ASP | 2.061 | | |
| | 22 | 20.000 | ASP | 2.000 | 1.52470 | 56.24 |
| | 23 | −14.286 | ASP | 1.381 | | |
| | 24 | INFINITY | | 0.300 | 1.556708 | 58.56 |
| | 25 | INFINITY | | 1.600 | | |
| | IMG | INFINITY | | 0.000 | | |

TABLE 14
Example 4/Aspheric surface data

| i | K | A4 | A6 | A8 | A10 |
|---|---|---|---|---|---|
| 5 | 0.0000E+00 | −1.0391E−04 | 1.2219E−06 | −4.3747E−08 | −2.6221E−10 |
| 6 | 0.0000E+00 | 7.5247E−05 | 2.3083E−06 | −1.1089E−07 | 1.1765E−09 |
| 7 | 0.0000E+00 | 1.6156E−04 | 3.6138E−05 | −3.4273E−06 | 1.3809E−07 |
| 8 | 0.0000E+00 | −5.3921E−04 | 5.2470E−05 | −3.8540E−06 | 3.4514E−07 |
| 12 | 0.0000E+00 | 1.2199E−04 | 3.3757E−05 | 2.7284E−06 | 1.6826E−07 |
| 13 | 0.0000E+00 | 4.6833E−04 | 2.5585E−05 | 3.4881E−06 | 1.8240E−07 |
| 15 | 0.0000E+00 | −1.4020E−04 | 4.2834E−06 | −3.6522E−07 | 1.1124E−08 |
| 20 | 0.0000E+00 | 7.5634E−06 | −9.8857E−06 | 0.0000E+00 | 0.0000E+00 |
| 21 | 0.0000E+00 | 3.0079E−04 | −1.5356E−05 | 0.0000E+00 | 0.0000E+00 |
| 22 | 0.0000E+00 | 7.5562E−04 | −3.3353E−05 | 0.0000E+00 | 0.0000E+00 |
| 23 | 0.0000E+00 | 1.8607E−03 | −6.4011E−05 | 2.3715E−07 | 9.8449E−09 |

TABLE 15
Example 4

| | Wide | | Telescopic |
|---|---|---|---|
| | angle end | Intermediate | end |
| f | 5.00 | 10.28 | 21.15 |
| Fno. | 3.61 | 3.93 | 4.87 |
| ω | 38.98 | 18.15 | 8.81 |
| d6 | 0.400 | 4.114 | 6.442 |
| d11 | 6.372 | 2.658 | 0.330 |
| d14 | 9.300 | 5.964 | 2.385 |
| d17 | 4.246 | 7.582 | 11.161 |

TABLE 16
Example 4

| Lens | First | Focal |
|---|---|---|
| group | surface | length |
| G1 | 1 | 12.500 |
| G2 | 7 | −3.842 |
| G3 | 12 | 11.633 |
| G4 | 15 | 12.193 |
| G5 | 18 | 22.641 |

### Numerical Example 5

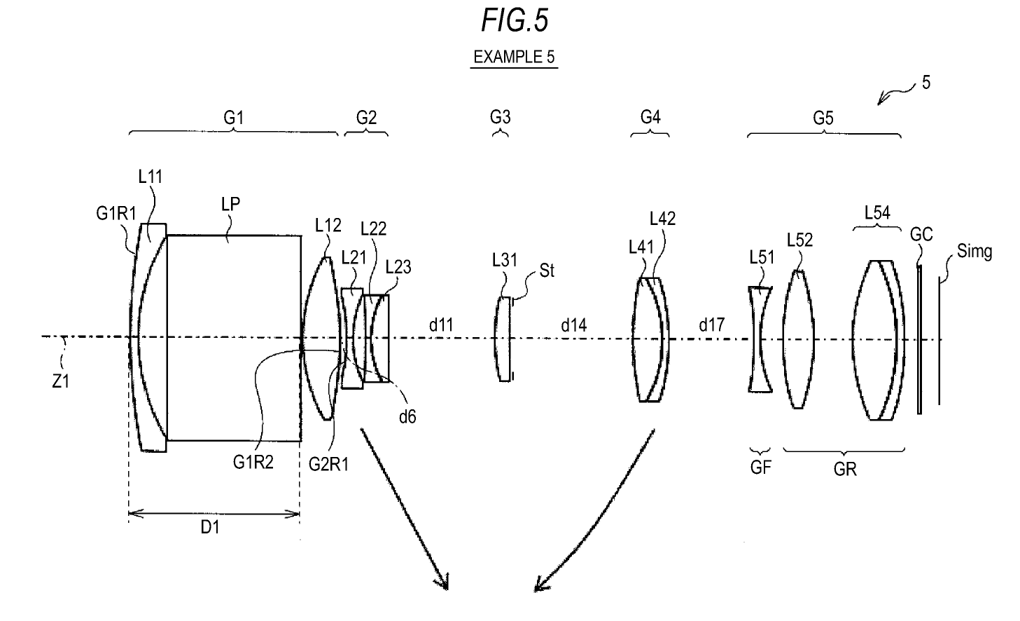

“Table 17” to “Table 20” show specific lens data corresponding to the zoom lens 5 according to the fifth exemplary configuration shown in FIG. 5. In particular, “Table 17” shows basic lens data on the zoom lens 5, and “Table 18” shows data on aspheric surfaces thereof. “Table 19” and “Table 20” show other data. Since the zoom lens 5 is so configured that the second lens group G2 and the fourth lens group G4 are moved when the magnification is changed, the inter-surface distances in front of and behind the lens groups G2 and G4 are variable. “Table 19” shows the variable inter-surface distances along with Fno., f, and co at the wide angle end, a point corresponding to an intermediate focal length, and the telescopic end. “Table 20” shows the surface number of the first surface and the focal length of each of the lens groups.

In the zoom lens 5, the first lens group G1 includes a negative meniscus lens (first lens L11), a prism that deflects the optical axis Z1 by 90° (reflective member LP), and a biconvex lens having aspheric surfaces on both sides (second lens L12) sequentially arranged from the object side. The second lens group G2 includes a biconcave lens L21 having aspheric surfaces on both sides and a doublet formed of a biconcave lens L22 and a positive lens L23 sequentially arranged from the object side. The third lens group G3 includes only a biconvex lens L31 having aspheric surfaces on both sides. The fourth lens group G4 includes a doublet formed of a biconvex lens L41 having an aspheric surface on the object side and a negative meniscus lens L42 sequentially arranged from the object side. The fifth lens group G5 includes a biconcave lens L51, a biconvex lens L52 having aspheric surfaces on both sides, and a doublet L54 formed of a biconvex lens having an aspheric surface on the object side and a meniscus lens sequentially arranged from the object side. The biconcave lens L51 forms the first lens partial group GF. The biconvex lens L52 and the doublet L54 form the second lens partial group GR.

TABLE 17
Example 5

| Lens | | | | | | |
|---|---|---|---|---|---|---|
| group | i | ri | ASP | di | ni | νi |
| G1 | 1 | 41.610 | | 0.500 | 2.00270 | 19.32 |
| | 2 | 12.822 | | 1.900 | | |
| | 3 | INFINITY | | 9.000 | 2.00100 | 29.13 |
| | 4 | INFINITY | | 0.130 | | |
| | 5 | 10.9209 | ASP | 2.452 | 1.72903 | 54.04 |
| | 6 | −18.475 | ASP | variable | | |
| G2 | 7 | −10.988 | ASP | 0.450 | 1.88202 | 37.22 |
| | 8 | 6.478 | ASP | 0.858 | | |
| | 9 | −24.196 | | 0.400 | 1.83481 | 42.72 |
| | 10 | 6.297 | | 1.127 | 1.94595 | 17.98 |
| | 11 | 41.155 | | variable | | |
| G3 | 12 | 12.3291 | ASP | 0.996 | 1.72903 | 54.04 |
| | 13 | −57.618 | ASP | 0.200 | | |
| | 14 (STO) | INFINITY | | variable | | |
| G4 | 15 | 17.351 | ASP | 1.966 | 1.75501 | 51.16 |
| | 16 | −7.860 | | 0.400 | 1.94595 | 17.98 |
| | 17 | −13.118 | | variable | | |
| G5 | 18 | −23.992 | | 0.500 | 2.00100 | 29.13 |
| | 19 | 8.364 | | 1.500 | | |
| | 20 | 15.893 | ASP | 2.107 | 1.52470 | 56.24 |
| | 21 | −11.218 | ASP | 2.600 | | |
| | 22 | 11.448 | ASP | 2.894 | 1.59201 | 67.02 |
| | 23 | −12.029 | | 0.600 | 2.00270 | 19.32 |
| | 24 | −15.035 | | 0.800 | | |
| | 25 | INFINITY | | 0.300 | 1.556708 | 58.56 |
| | 26 | INFINITY | | 1.130 | | |
| | IMG | INFINITY | | 0.000 | | |

TABLE 18
Example 5/Aspheric surface data

| i | K | A4 | A6 | A8 | A10 |
|---|---|---|---|---|---|
| 5 | 0.0000E+00 | −5.4526E−05 | 2.0465E−06 | −1.7474E−07 | 5.8000E−09 |
| 6 | 0.0000E+00 | 1.8315E−04 | 1.6232E−07 | −1.0035E−07 | 4.7270E−09 |
| 7 | 0.0000E+00 | −8.3927E−04 | 2.7068E−04 | −2.1658E−05 | 6.4058E−07 |
| 8 | 0.0000E+00 | −2.1513E−03 | 2.8700E−04 | −1.3815E−05 | −1.3487E−07 |
| 12 | 0.0000E+00 | 3.9513E−04 | 7.1785E−05 | −7.0510E−06 | 8.4815E−07 |
| 13 | 0.0000E+00 | 6.1460E−04 | 8.3051E−05 | −8.1635E−06 | 9.7866E−07 |
| 15 | 0.0000E+00 | −2.0625E−04 | 5.5126E−06 | −4.6993E−07 | 1.4877E−08 |
| 20 | 0.0000E+00 | 3.0770E−04 | −7.3010E−06 | 0.0000E+00 | 0.0000E+00 |
| 21 | 0.0000E+00 | 5.5044E−04 | −8.7837E−06 | 0.0000E+00 | 0.0000E+00 |
| 22 | 0.0000E+00 | 1.8459E−05 | −6.1419E−06 | 0.0000E+00 | 0.0000E+00 |

TABLE 19
Example 5

| | Wide | | Telescopic |
|---|---|---|---|
| | angle end | Intermediate | end |
| f | 4.58 | 10.90 | 25.90 |
| Fno. | 3.59 | 4.11 | 5.04 |
| ω | 42.34 | 18.33 | 7.82 |
| d6 | 0.400 | 4.384 | 7.101 |
| d11 | 7.101 | 3.116 | 0.400 |
| d14 | 8.095 | 4.915 | 2.101 |
| d17 | 5.594 | 8.775 | 11.588 |

TABLE 20
Example 5

| Lens | First | Focal |
|---|---|---|
| group | surface | length |
| G1 | 1 | 11.438 |
| G2 | 7 | −3.688 |
| G3 | 12 | 13.954 |
| G4 | 15 | 11.269 |
| G5 | 18 | 13.140 |

### Other Numerical Data In Examples

“Table 21” shows values related to the conditional expressions described above with respect to each of Numerical Examples. As seen from “Table 21,” the values in each of Numerical Examples fall within the acceptable ranges defined by the conditional expressions.

TABLE 21

| Conditional expressions | Example 1 | Example 2 | Example 3 | Example 4 | Example 5 |
|---|---|---|---|---|---|
| (1) 1.1 < β5 < 1.56 | 1.51 | 1.47 | 1.36 | 1.35 | 1.37 |
| (2) 0.1 < \|F5/Ft\| < 4 | 1.4 | 0.9 | 0.9 | 1.1 | 0.5 |
| (3) \|Fw/G1R1\| < 1.0 | 0.12 | 0.12 | 0.01 | 0.21 | 0.50 |
| (4) NdGF > 1.9 | 2.00060 | 2.00100 | 2.00060 | 2.00060 | 2.00100 |
| (5) 0.6 < \|FGF/Fw\| < 2.0 | 1.19 | 1.20 | 1.23 | 1.34 | 1.33 |
| (6) 1.2 < G1R2/G2R1 < 2.0 | 1.64 | 1.64 | 1.69 | 1.38 | 1.68 |
| (7) 0.7 < \|F1/(Fw × Ft)^{1/2}\| < 1.5 | 1.20 | 1.19 | 1.17 | 1.22 | 1.05 |
| (8) D1/{(Ft/Fw) × tan(ωw)} < 5.0 | 3.17 | 3.45 | 3.66 | 3.93 | 3.17 |
| (9) NdG1 > 1.9 | 2.00270 | 2.00270 | 2.00270 | 2.00270 | 2.00270 |
| (10) NdPr > 1.9 | 2.00100 | 2.00100 | 2.00100 | 1.90366 | 2.00100 |

### Aberration Correction

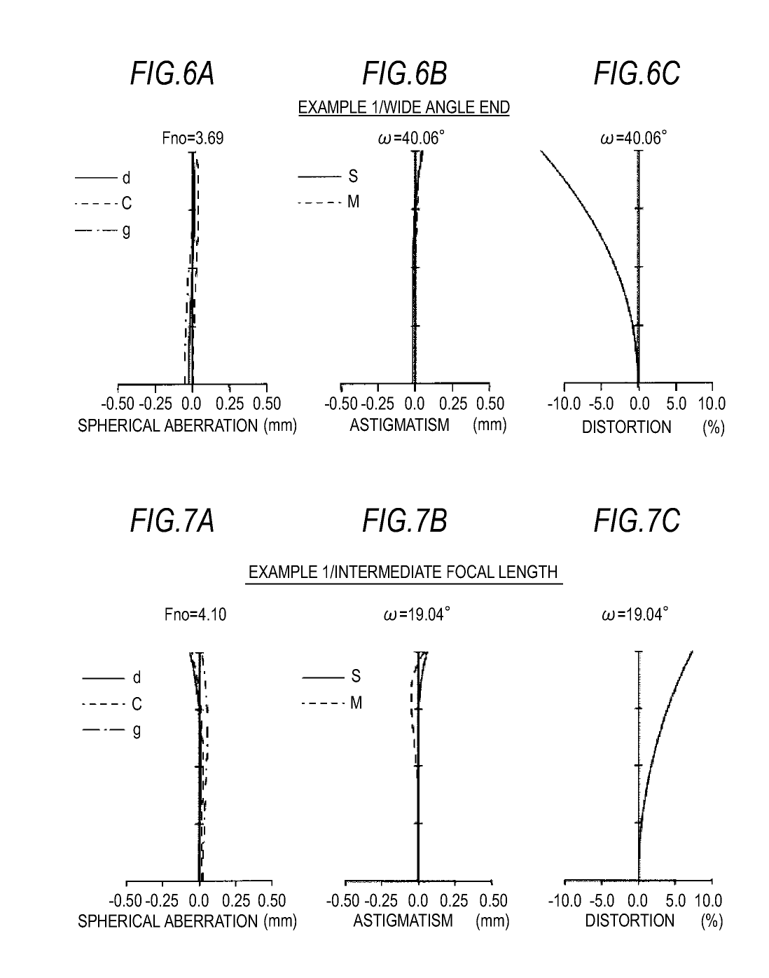

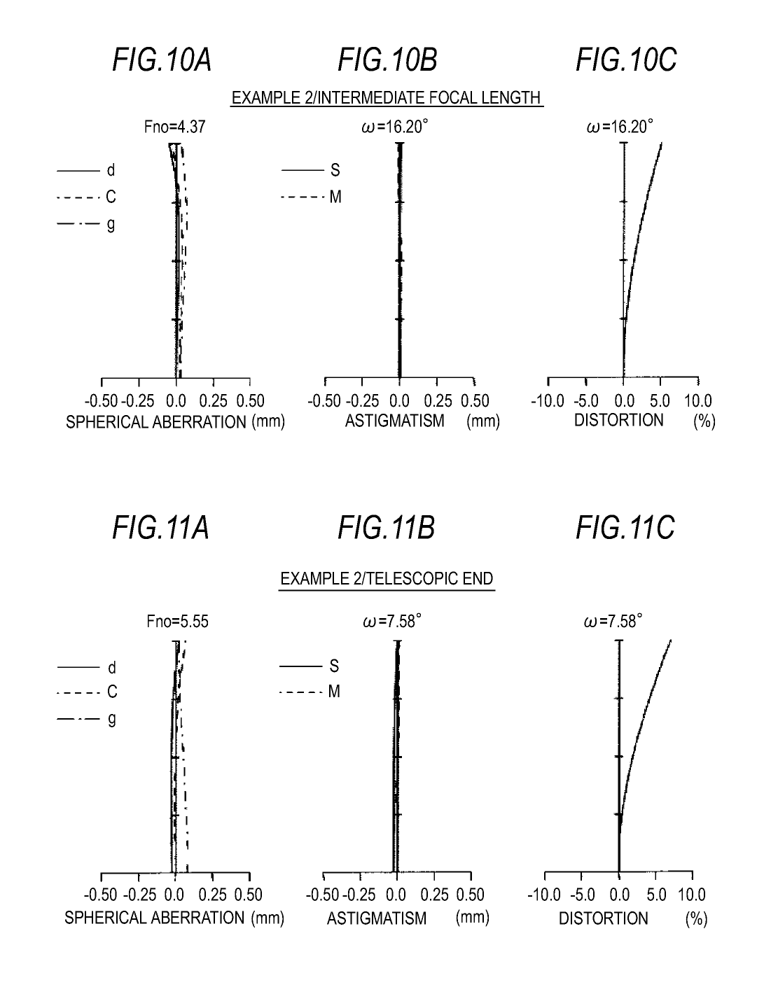

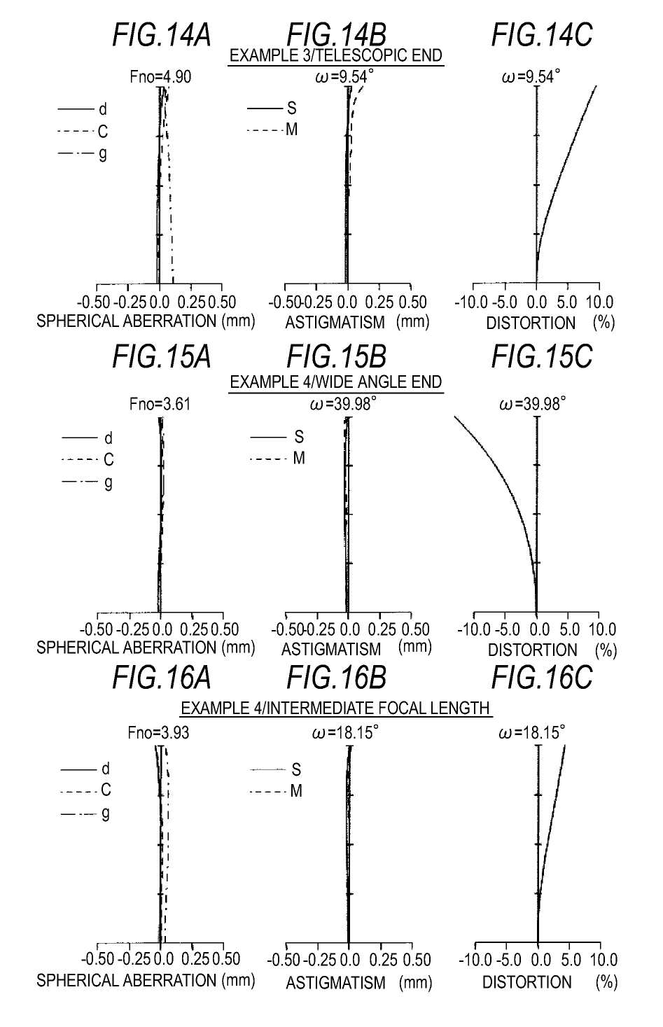

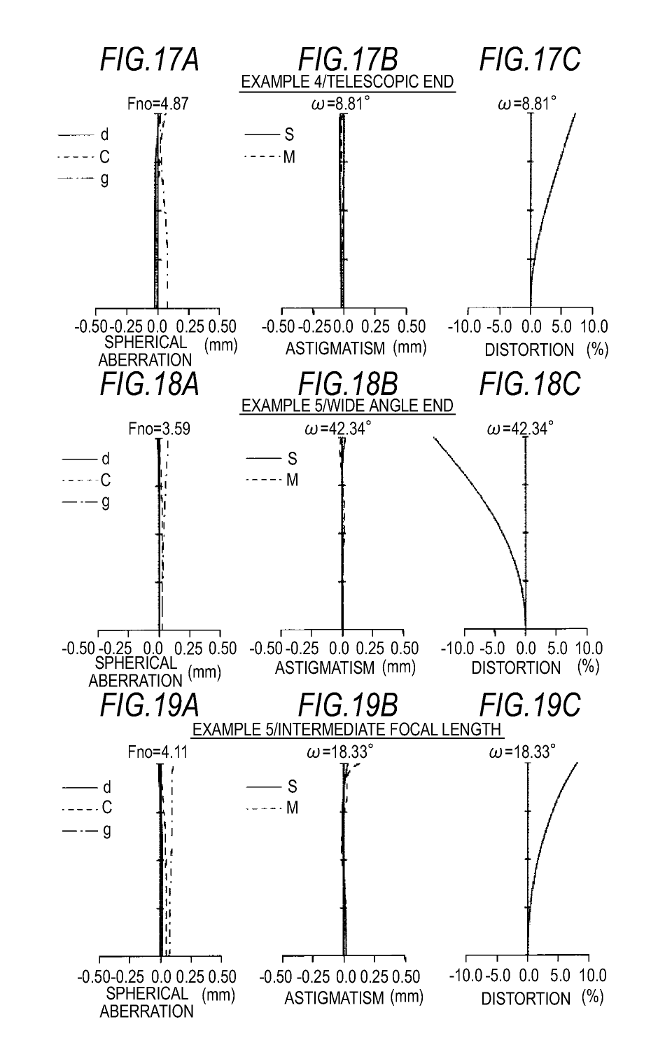

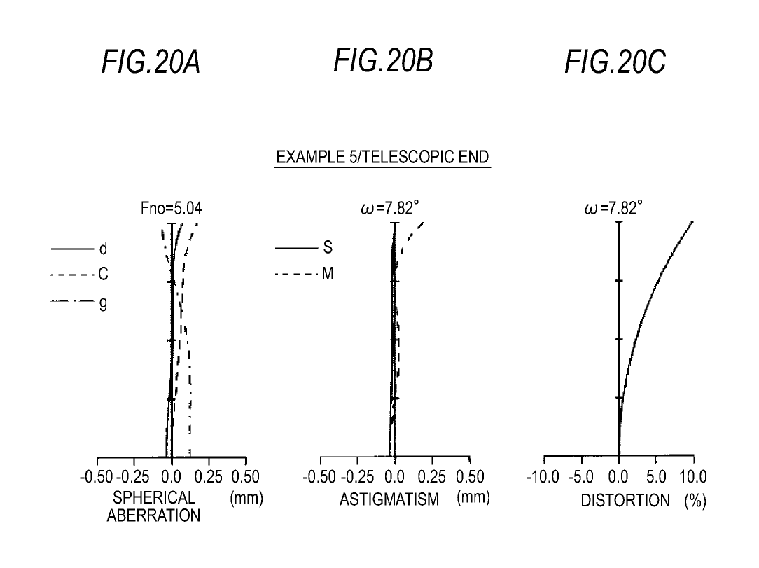

FIGS. 6A to 6C to FIGS. 20A to 20C show aberration correction in Numerical Examples. The aberrations shown in FIGS. 6A to 6C to FIGS. 20A to 20C are produced when an object at infinity is brought into focus.

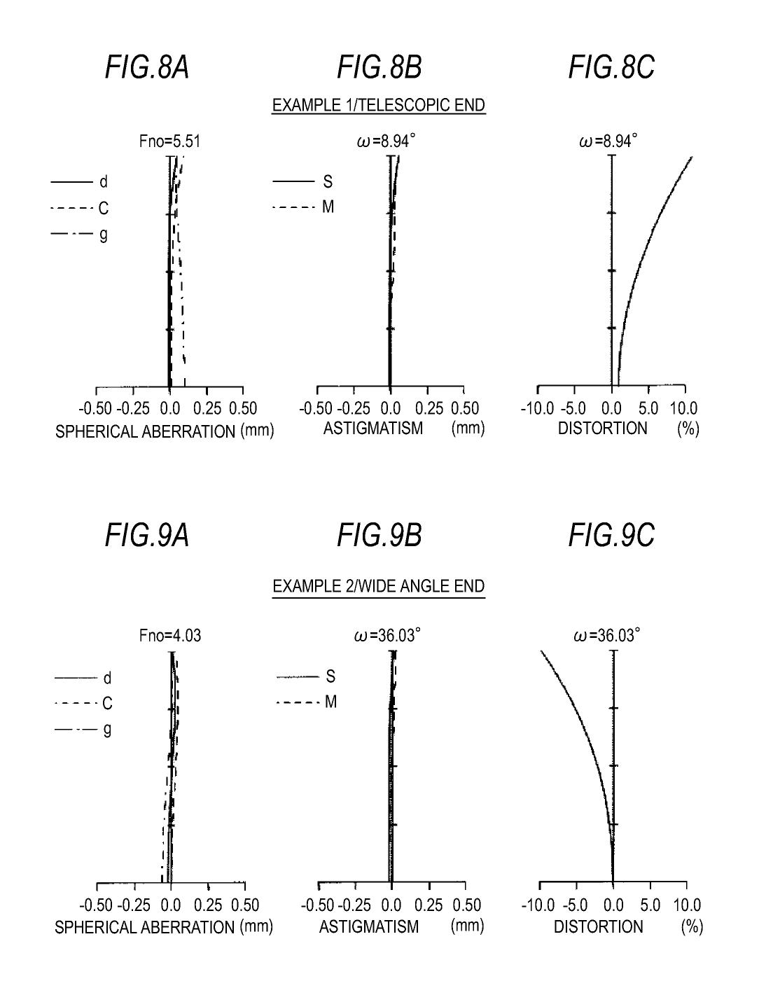

FIGS. 6A to 6C show spherical aberration, astigmatism, and distortion produced by the zoom lens 1 corresponding to Numerical Example 1 at the wide angle end. FIGS. 7A to 7C show the same aberrations produced at a point corresponding to an intermediate focal length. FIGS. 8A to 8C shows the same aberrations produced at the telescopic end. The aberrations shown in the aberration diagrams are produced at the d line (587.6 nm) as a reference wavelength. The spherical aberration diagrams also show aberrations calculated at the g line (435.84 nm) and the C line (656.28 nm). In the astigmatism diagrams, S (solid lines) represents astigmatism in the sagittal direction, and M (broken lines) represents astigmatism in the meridional direction. “Fno” denotes an f-number, and “ω” denotes a half angle of view.

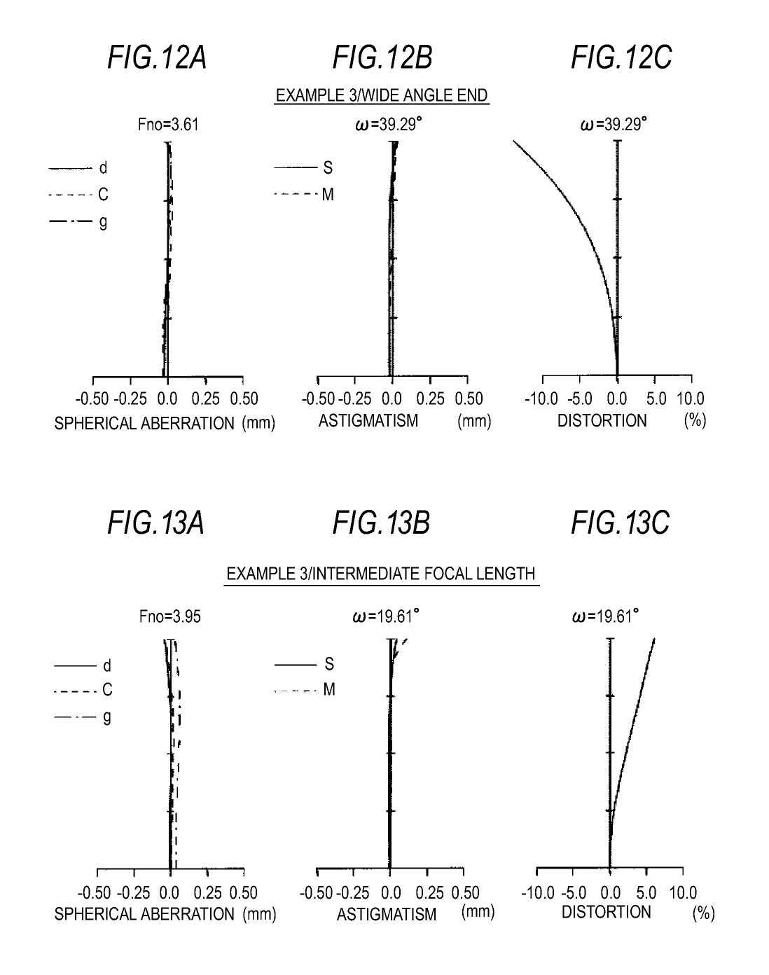

Similarly, FIGS. 9A to 9C to FIGS. 11A to 11C show spherical aberration, astigmatism, and distortion produced by the zoom lens 2 corresponding to Numerical Example 2. Similarly, FIGS. 12A to 12C to FIGS. 14A to 14C show spherical aberration, astigmatism, and distortion produced by the zoom lens 3 corresponding to Numerical Example 3. Similarly, FIGS. 15A to 15C to FIGS. 17A to 17C show spherical aberration, astigmatism, and distortion produced by the zoom lens 4 corresponding to Numerical Example 4. Similarly, FIGS. 18A to 18C to FIGS. 20A to 20C show spherical aberration, astigmatism, and distortion produced by the zoom lens 5 corresponding to Numerical Example 5.

The aberration diagrams described above show that the aberration are corrected in a well balanced manner and excellent image forming performance is achieved in each of the different magnification areas, at the wide angle end, at a point corresponding to an intermediate focal length between the wide angle end and the telescopic end, and at the telescopic end in each of Examples.

Further, the zoom lens achieved in each of Examples has a wide angle of view ranging from about 70° to 90° at the wide angle end and a high zoom ratio ranging from about 4 to 6.

### Other Embodiments

The technology according to the present disclosure is not necessarily implemented in the embodiment and the examples described above but can be implemented in a variety of variations.

For example, the shapes and values of the components shown in Numerical Examples described above are presented only by way of example for implementing the present disclosure and should not limit the technical scope of the present technology.

Further, the above embodiment and examples have been described with reference to the case where each of the zoom lenses is formed of five lens groups but the zoom lens may further include a lens having substantially no power.

Further, the present disclosure may, for example, be implemented as the following configurations.

[1] A zoom lens including a first lens group having positive power and fixed during zooming operation, a second lens group having negative power, a third lens group having positive power, a fourth lens group having positive power, and a fifth lens group having positive power sequentially arranged from a side where an object is present,

wherein the zooming operation is performed by moving at least the second lens group and the fourth lens group,

the first lens group includes a reflective member that deflects an optical path,

the fifth lens group includes a first lens partial group having negative power and a second lens partial group having positive power sequentially arranged from the object side, and

the zoom lens satisfies the following conditional expressions:

1.1<β5<1.56 (1)

0.1<|F5/Ft|<4 (2)

where β5 represents lateral magnification of the fifth lens group, F5 represents the focal length of the fifth lens group, and Ft represents the focal length of the entire system at a telescopic end.

[2] The zoom lens described in [1],

wherein the first lens group includes a first lens, which is a single lens having negative power, the reflective member, and a second lens having positive power sequentially arranged from the object side, and

the zoom lens satisfies the following conditional expression:

|Fw/G1R1|<1.0 (3)

where G1R1 represents the radius of curvature of an object-side surface of the first lens, and Fw represents the focal length of the entire system at a wide angle end.

[3] The zoom lens described in [1] or [2],

wherein the first lens partial group is formed of a single lens having negative power, and the zoom lens satisfies the following conditional expressions:

NdGF>1.9 (4)

0.6<|FGF/Fw|<2.0 (5)

where NdGF represents the refractive index of the first lens partial group at the d line, and FGF represents the focal length of the first lens partial group.

[4] The zoom lens described in any one of [1] to [3],

wherein the zoom lens satisfies the following conditional expression:

1.2<G1R2/G2R1<2.0 (6)

where G1R2 represents the radius of curvature of a surface closest to a side where an image is formed in the first lens group, and G2R1 represents the radius of curvature of a surface closest to the object side in the second lens group.

[5] The zoom lens described in any one of [1] to [4],

wherein the zoom lens satisfies the following conditional expressions:

0.7<|F1/(Fw×Ft)^{1/2}|<1.5 (7)

D1/{(Ft/Fw)×tan(ωw)}<5.0 (8)

where F1 represents the focal length of the first lens group, D1 represents the distance along an optical axis from a surface closest to the object side in the first lens group to an image-side surface of the reflective member, and cow represents the angle of view at the wide angle end.

[6] The zoom lens described in [2],

wherein the zoom lens satisfies the following conditional expressions:

NdG1>1.9 (9)

NdPr>1.9 (10)

where NdG1 represents the refractive index of the first lens in the first lens group at the d line, and NdPr represents the refractive index of the reflective member at the d line.

[7] The zoom lens described in any one of [1] to [6],

further including a lens having substantially no power.

[8] An imaging apparatus including a zoom lens and an imaging device that outputs a captured signal according to an optical image formed by the zoom lens,

wherein the zoom lens includes a first lens group having positive power and fixed during zooming operation, a second lens group having negative power, a third lens group having positive power, a fourth lens group having positive power, and a fifth lens group having positive power sequentially arranged from a side where an object is present,

the zooming operation is performed by moving at least the second lens group and the fourth lens group,

the first lens group includes a reflective member that deflects an optical path,

the fifth lens group includes a first lens partial group having negative power and a second lens partial group having positive power sequentially arranged from the object side, and

the zoom lens satisfies the following conditional expressions:

1.1<β5<1.56 (1)

0.1<|F5/Ft|<4 (2)

where β5 represents lateral magnification of the fifth lens group, F5 represents the focal length of the fifth lens group, and Ft represents the focal length of the entire system at a telescopic end.

[9] The imaging apparatus described in [8],

further including a signal processor that performs distortion correction on a captured image produced from the captured signal.

[10] The imaging apparatus described in [8] or [9],

wherein the zoom lens further includes a lens having substantially no power.

The present disclosure contains subject matter related to that disclosed in Japanese Priority Patent Application JP 2011-189616 filed in the Japan Patent Office on Aug. 31, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A zoom lens comprising:
a first lens group having positive power and fixed during zooming operation;
a second lens group having negative power;
a third lens group having positive power;
a fourth lens group having positive power; and
a fifth lens group having positive power sequentially arranged from a side where an object is present,
wherein the zooming operation is performed by moving at least the second lens group and the fourth lens group,
the first lens group includes a reflective member that deflects an optical path,
the fifth lens group includes a first lens partial group having negative power and a second lens partial group having positive power sequentially arranged from the object side, and
the zoom lens satisfies the following conditional expressions
1.1<β5<1.56 (1)
0.1<|F5/Ft|<4 (2)
where β5 represents lateral magnification of the fifth lens group, F5 represents the focal length of the fifth lens group, and Ft represents the focal length of the entire system at a telescopic end.

2. The zoom lens according to claim 1,
wherein the first lens group includes a first lens, which is a single lens having negative power, the reflective member, and a second lens having positive power sequentially arranged from the object side, and
the zoom lens satisfies the following conditional expression

|Fw/G1R1|<1.0 (3)
where G1R1 represents the radius of curvature of an object-side surface of the first lens, and Fw represents the focal length of the entire system at a wide angle end.

3. The zoom lens according to claim 1,
wherein the first lens partial group is formed of a single lens having negative power, and
the zoom lens satisfies the following conditional expressions
NdGF>1.9 (4)
0.6<|FGF/Fw|<2.0 (5)
where NdGF represents the refractive index of the first lens partial group at the d line, and FGF represents the focal length of the first lens partial group.

4. The zoom lens according to claim 1,
wherein the zoom lens satisfies the following conditional expression
1.2<G1R2/G2R1<2.0 (6)
where G1R2 represents the radius of curvature of a surface closest to a side where an image is formed in the first lens group, and G2R1 represents the radius of curvature of a surface closest to the object side in the second lens group.

5. The zoom lens according to claim 1,
wherein the zoom lens satisfies the following conditional expressions
0.7<|F1/(Fw×Ft)^{1/2}|<1.5 (7)
D1/{(Ft/Fw)×tan(ωw)}<5.0 (8)
where F1 represents the focal length of the first lens group, D1 represents the distance along an optical axis from a surface closest to the object side in the first lens group to an image-side surface of the reflective member, and cow represents the angle of view at the wide angle end.

6. The zoom lens according to claim 2,
wherein the zoom lens satisfies the following conditional expressions
NdG1>1.9 (9)
NdPr>1.9 (10)
where NdG1 represents the refractive index of the first lens in the first lens group at the d line, and NdPr represents the refractive index of the reflective member at the d line.

7. An imaging apparatus comprising:
a zoom lens; and
an imaging device that outputs a captured signal according to an optical image formed by the zoom lens,
wherein the zoom lens includes a first lens group having positive power and fixed during zooming operation, a second lens group having negative power, a third lens group having positive power, a fourth lens group having positive power, and a fifth lens group having positive power sequentially arranged from a side where an object is present,
the zooming operation is performed by moving at least the second lens group and the fourth lens group,
the first lens group includes a reflective member that deflects an optical path,
the fifth lens group includes a first lens partial group having negative power and a second lens partial group having positive power sequentially arranged from the object side, and
the zoom lens satisfies the following conditional expressions
1.1<β5<1.56 (1)
0.1<|F5/Ft|<4 (2)
where β5 represents lateral magnification of the fifth lens group, F5 represents the focal length of the fifth lens group, and Ft represents the focal length of the entire system at a telescopic end.

8. The imaging apparatus according to claim 7,
further comprising a signal processor that performs distortion correction on a captured image produced from the captured signal.
